(19) United States
(12) Patent Application Publication
(10) Pub. No.: US 2013/0159045 A1
(43) Pub. Date: Jun. 20, 2013

(54) ROBUST INVENTORY MANAGEMENT IN MULTI-STAGE INVENTORY NETWORKS WITH DEMAND SHOCKS

(71) Applicants: Markus R. Ettl, Ossining, NY (US); Marco Laumanns, Zurich (CH); Marek Petrik, Croton-on-Hudson, NY (US); Rajesh Kumar Ravi, Yorktown Heights, NY (US); Stefan Woerner, Zurich (CH)

(72) Inventors: Markus R. Ettl, Ossining, NY (US); Marco Laumanns, Zurich (CH); Marek Petrik, Croton-on-Hudson, NY (US); Rajesh Kumar Ravi, Yorktown Heights, NY (US); Stefan Woerner, Zurich (CH)

(73) Assignee: INTERNATIONAL BUSINESS MACHINES CORPORATION, Armonk, NY (US)

(21) Appl. No.: 13/325,672

(22) Filed: Dec. 14, 2011

(51) Int. Cl. G06Q 10/08

(52) U.S. Cl. 705/7.25

(57) ABSTRACT

Robust inventory management for a supply chain network with multiple nodes may include generating a time-phased inventory deployment plan based on extreme samples and dynamic supply chain structure. The extreme samples of demand and supply chain scenarios, and dynamic supply chain structure including one or more resource constraints associated with one or more nodes in the supply chain network may be received from a user.

### STATEMENT REGARDING FEDERALLY SPONSORED RESEARCH OR DEVELOPMENT

This invention was made with Government support under Contract No.: HSFEHQ-07-F-1049 awarded by Federal Emergency Management Administration (FEMA). The Government has certain rights in this invention.

### FIELD

The present application relates generally to operations research and automated computer applications, and more particularly to robust inventory planning.

### BACKGROUND

Inventory management in a network of supply chain involving multiple stock nodes (distribution locations) includes determining how much and when to deliver and ship stock from one location to another in the network of supply chain. Operational and planning tools for such inventory management may take into consideration the resource constraints such as available transportation, storage and throughput in planning and operating inventory. Inventory management also means taking into consideration the uncertainties, since the actual demand in many instances are known before responding (e.g., stocking).

To accurately optimize for future demands in inventory, methodologies such as heuristics, stochastic programming or approximate dynamic programming have been utilized. In operation, those methodologies work from a known distribution of the uncertain demands. For example, uncertainties are represented as probability distributions. Often, however, the distributions are unknown. For example, there may be insufficient data or domain knowledge to be able to compute demand distribution and supply chain properties. Furthermore, much of the existing inventory management tools only deal with a single stock node, not multiple nodes (e.g., multiple locations of supply and demand) in a network.

An example in which demand distribution may not be known is in responding to disasters where a surge in demand needs to be met unexpectedly. Successful response to disasters requires that large quantities of emergency goods and supplies are distributed rapidly and widely. The supply chain developed for handling disasters differs from standard commercial supply chains in many ways. First, the delivery of goods is not driven by optimizing profit, but instead by fulfilling humanitarian needs. Second, while commercial supply chains can be often precisely designed and refined due to slowly changing customer demand, the supply chains in disaster response must be set up rapidly with little advance warning and unknown demands. Finally, since disasters rarely repeat, there is generally insufficient data to construct faithful models.

Previous work in robust optimization for inventory management assumes several simplifications that limit its practical applicability. (See, e.g., Dimitris Bertsimas and Aurelie Thiele. A Robust Optimization Approach to Inventory Theory. Operations Research, 2006). In particular, it assumes that the uncertainty is restricted by a budget but has a rectangular shape, which means that the disturbances are independent across stock nodes and time. In addition, this work only considers static policies that do not respond to learning the outcomes of the uncertainty.

Affine controllers represent a compromise between static policies and fully adjustable policies. Static policies may be easy to compute but cannot respond to additional information about demand deviations. Fully adjustable policies can respond to learning additional information but are hard to compute. Truncated affine controllers represent a piecewise extension of affine controllers. These approaches, though, require that the uncertainty is rectangular to make their computation tractable. Rectangularity assumption makes sense in regular inventory settings, when backlog is rare. However, in emergency settings, the backlog is rarely small.

Other known methodologies compute fixed s-S policies for all stock nodes and fixed sourcing. However, the structure, capacities and throughput of nodes may change over time, which may render the fixed computational methodologies inaccurate.

### BRIEF SUMMARY

A method for inventory management for a supply chain network with multiple nodes, in one aspect, may include receiving extreme samples of demand and supply chain scenarios. The method may also include receiving dynamic supply chain structure including one or more resource constraints associated with one or more nodes in the supply chain network. The method may further include generating a time-phased inventory deployment plan based on the extreme samples and the dynamic supply chain structure. The method may also include outputting said time-phased inventory deployment plan.

A system for inventory management for a supply chain network with multiple nodes, in one aspect, may include a processor operable to receive extreme samples of demand and supply chain scenarios, and dynamic supply chain structure including one or more resource constraints associated with one or more nodes in the supply chain network. The processor may be further operable to generate a time-phased inventory deployment plan based on said extreme samples and the dynamic supply chain structure. The processor may be further operable to output the time-phased inventory deployment plan.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a supply chain network in which a methodology of the present disclosure may be applied for optimizing inventory.

FIG. 2 illustrates the uncertainty in the demand forecasts for a single factor in one embodiment of the present disclosure.

FIG. 3 illustrates how the use of fairness measures encourages penalized coverage that is not uniform in one embodiment of the present disclosure.

FIG. 4 illustrates an example of factored representation of uncertainty in one embodiment of the present disclosure.

FIG. 5 illustrates an example of sampled plausible demand scenarios in one embodiment of the present disclosure.

FIG. 6 is a flow diagram illustrating a methodology for robust optimization in one embodiment of the present disclosure.

FIG. 7 shows an example of a feasible set of uncertainties for two factors.

FIG. 8 is a flow diagram illustrating a method of the present disclosure in one embodiment.

FIG. 9 illustrates a schematic of an example computer or processing system that may implement the robust inventory planning system in one embodiment of the present disclosure.

### DETAILED DESCRIPTION

A robust optimization methodology is disclosed in one embodiment of the present disclosure. Robust optimization is an alternative model of uncertainty to the more traditional stochastic optimization. Instead of computing solutions that work well in expectation with respect to some distribution, it computes solutions that are guaranteed to work well in all plausible realization of the uncertainty; it can be seen as an immunization against the effects of the uncertainty. To specify a robust uncertainty set, one only needs to define what is plausible and does not need to define the actual probabilities. In addition, the robust approach does not suffer from some of the out of sample extension problem associated with some of the sample-based stochastic optimization algorithms, such as approximate dynamic programming.

The robust optimization methodology of the present disclosure in one embodiment does not require that the uncertainty is rectangular. Instead, to achieve tractability, the methodology of the present disclosure in one embodiment may assume uncertainty sets that are a convex combination of a small number of instantiations. Further, the methodology of the present disclosure may allow for balancing of the backlog at multiple nodes; Objective functions may be developed that can be used to achieve fair coverage over multiple stock nodes, In addition, to enable the scalability of the approach, a factored representation of the uncertainty set is developed which can capture sparse correlations between the demands. The methodology of the present disclosure in one embodiment enables computing of optimal and close-to-optimal solutions to the inventory management problems, for instance, instead of relying on heuristic solution.

The optimization methodology of the present disclosure may address managing inventory where the demands exhibit uncertainty. The methodology in one embodiment computes a solution that is immunized against the uncertainty, for instance, using a factorized structure of the demand disturbances, the uncertainty being modeled by causes and not effects.

The methodology of the present disclosure in one embodiment may maximize coverage, i.e., the percentage of satisfied demand, in inventory settings that may have nonstationary demand spikes or shocks, dynamic supply chain structure, lack of historical data and thus no distribution, and where fair coverage needs to be achieved, Dynamic supply chain structure may be caused by changes in the supply chain network and transportation routes, e.g., road damages.

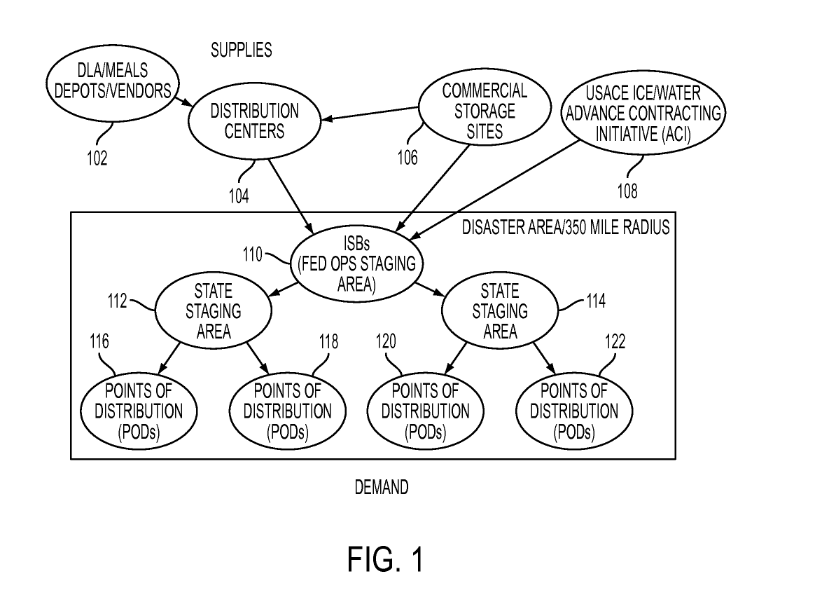

FIG. 1 illustrates a supply chain network in which a methodology of the present disclosure may be applied for optimizing inventory. The supply chain network includes multiple supply and demand nodes. For example, the supply chain network nodes may include depots and vendors 102, distribution centers 104, commercial storage sites 106, advance contracting initiative sites 108, for example, that supply goods. The supply chain network may also include staging areas 110, 112, 114 and points of distribution 116, 118, 120, 122 where the goods are distributed to the end nodes or individuals.

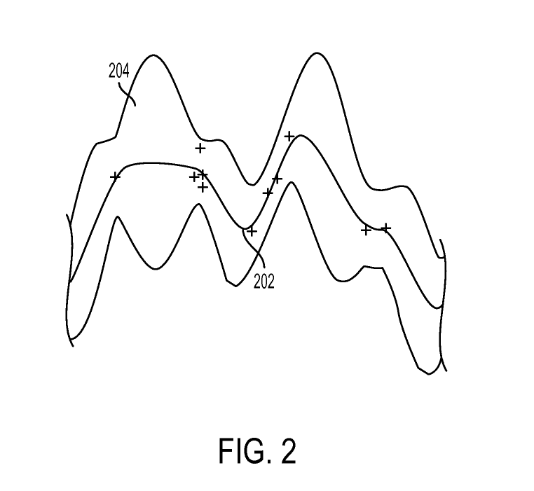

Robust optimization in the present disclosure in one embodiment immunize against uncertainty by computing solutions that work well for all or substantially all instantiations of uncertainties. In one embodiment, uncertainty set may be defined by a set of plausible worst case samples factored by regions. FIG. 2 illustrates the uncertainty in the demand forecasts for a single factor. The line at 202 represents forecasted demand. The buffered areas 204 around the forecasted demand line 202 represent the degree of uncertainty.

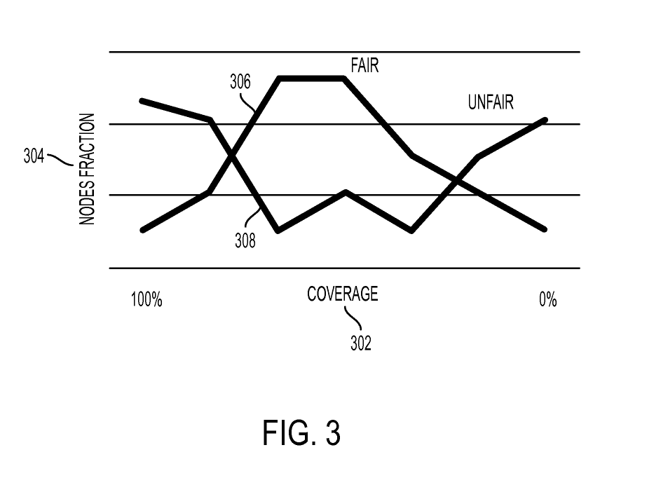

In another embodiment of the present disclosure, uniform coverage in percentage of satisfied demand provides fairness in coverage, i.e., balancing total goods delivered and uniform coverage. Fairness in one embodiment is a scale and multiple results may be comparable. A new class of fairness measure is disclosed that represents fairness and is computationally convenient. FIG. 3 illustrates how the use of fairness measures encourages penalized coverage that is not uniform. In particular, the “unfair” scenario 308 achieves average coverage identical to the “fair” scenario 306, but there are many nodes with low and high coverage. The coverage in the “fair” scenario is much more even. The y-axis 304 represents the fraction of nodes covered. The x-axis 302 measures the amount of coverage, i.e., a percentage of demand satisfied at a supply chain network node. Demand is deemed to be satisfied at a node if goods are available at the node at the time the goods are demanded, e.g., by another node or an end point of the distribution such as an individual. Coverage fairness in one embodiment of the present disclosure also may aim to achieve fairness of the coverage across multiple nodes and time steps.

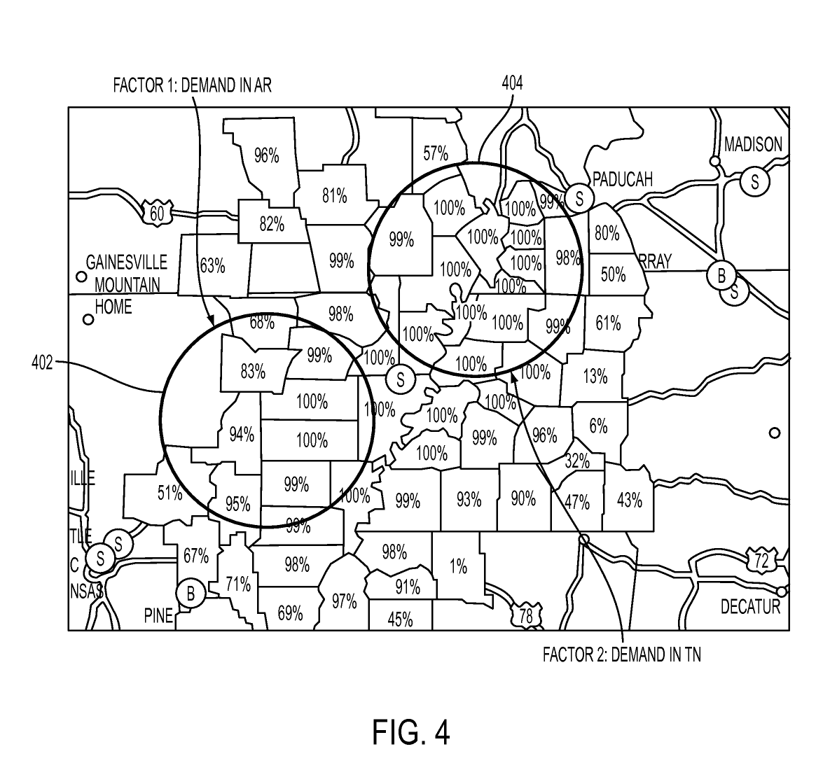

Managing inventory in one embodiment of the present disclosure, for example, under incomplete information may include factored representation of uncertainty. Demand deviations are modeled to depend on high-level unpredicted events and the response is modeled to depend on these same unpredicted events. In one embodiment of the present disclosure, the response is modeled by linearly adjustable controllers as described below. FIG. 4 illustrates an example of factored representation of uncertainty in one embodiment of the present disclosure. The demand in this example is a result of a disaster—the percentage value in the figure represents the expected fraction of the population affected in the areas. The true fraction of the population affected may be much lower or much higher, depending on the precise location of the disaster, e.g., epicenter. There are two factors in this example. Factor 1 402 represents the demand in area 1 and is high if the epicenter is located in area 1; Factor 2 404 represents the demand in area 2 and is high if the epicenter is located there. An intermediate location of the epicenter leads to an intermediate demand.

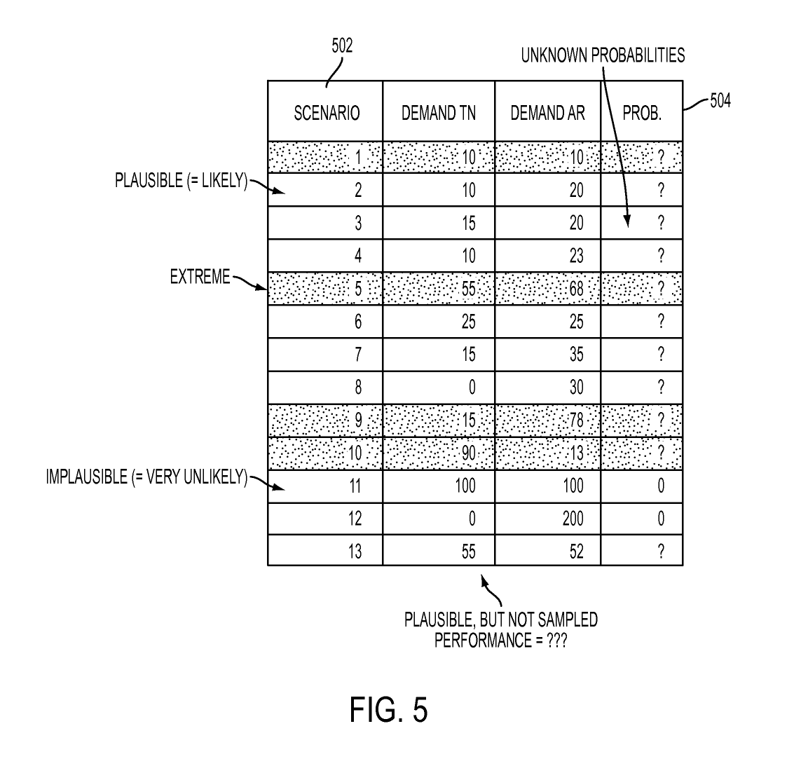

Managing inventory in one embodiment of the present disclosure, for example, under incomplete information also may include sampled plausible demand scenarios, which are instantiations of uncertainties for the extreme plausible cases, and which work well for milder events even when not sampled. FIG. 5 illustrates an example of sampled plausible demand scenarios in one embodiment of the present disclosure. The setting of the example is identical to the example in FIG. 4. There are 13 potential scenarios (shown in column 502) of demand realization, identified as number 1 through 13. The first 10 scenarios are plausible but with unknown probabilities (shown in the probabilities column at 504 in FIG. 5 by question mark symbols); scenarios 11 and 12 are too extreme and their likelihood is very low. Scenarios 1, 5, 9, and 10 are the worst possible (most extreme) plausible scenarios. Scenario 13 is also plausible but does not have to be provided as a part of the description because it is more moderate than scenario 5. in one embodiment of the present disclosure, the extreme values are input by a user and define the space of plausible demand values. Geometrically, the plausible demands are a convex combination of the extreme demands. The uncertain demand can then be realized—that is, actually occur—from anywhere in this plausible set.

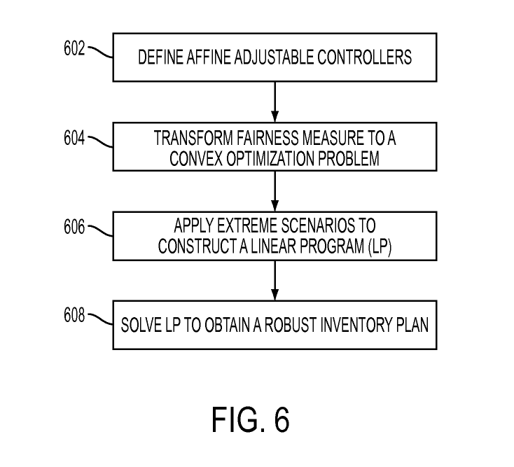

FIG. 6 is a flow diagram illustrating a methodology for robust optimization in one embodiment of the present disclosure. At 602, affine adjustable controllers are defined, Solution is parameterized by uncertainty values and a response depends linearly on disturbances:

$${min}_{Y ∈ \overline{Y}} {max}_{x ∈ X} μ ( Y ( x ) )$$

This equation shows in one embodiment the optimization used to compute the adjustable controller used to respond to the demand. Here, Y̅ represents the space of adjustable controllers that should be considered, X represents the set of plausible demands, and μ is the fairness measure, such as a plain average for example. The above equation represents computing the best possible inventory plan y for the worst-case plausible realization of the demand x . The worst-case plausible realization of demand is an actual realization of the demand that leads to the worst coverage for the given inventory plan.

Optionally at 604, the methodology in one embodiment of the present disclosure takes Fenchel-Legendre transform of the fairness measure. For example, the methodology of the present disclosure in one embodiment transforms fairness measure to a convex optimization problem:

$$μ ( x ) = {max}_{q ∈ Q} {q}^{T} x - {f}^{*} ( q )$$

This equation describes a possible representation of a fairness measure. In the simplest example, when μ is a simple average, the set Q is a single element of all constant values 1/|x| where |x| is the size of x. The set Q is a convex polyhedral set and f* is a convex continuous function; both these values represent the possible importance of each node and are provided by the user based on their preferences in one embodiment of the present disclosure.

At 606, extreme scenarios are applied to construct a linear program (LP):

$$\begin{matrix}{min}_{Y ∈ \overline{Y}} {max}_{x ∈ X} μ ( Y ( x ) ) = {min}_{Y ∈ \overline{Y}} {max}_{x ∈ X} {max}_{q ∈ Q} {q}^{T} Y ( x ) - {f}^{*} ( q ) \\ = {min}_{Y ∈ \overline{Y}} {max}_{x ∈ ext ( X )} {max}_{q ∈ Q} {q}^{T} Y ( x ) - {f}^{*} ( q ) \\ = LP\end{matrix}$$

This equation shows in one embodiment the optimization used to compute the adjustable controller used to respond to the demand. The notation q^{T} represents the transpose of the vector q; the value q^{T}Y(x) represents the inner product between the two vectors and could be also denoted as <q, Y(x)>. Here, Y̅ represents the space of adjustable controllers that should be considered, X represents the set of plausible demands, and μ is the fairness measure, such as a plain average for example. Each element of Y̅ is a function that maps a realization of the uncertainty x to a vector of deliveries at each node. The optimization corresponds to computing the best possible inventory plan y for the worst possible realization of the demand x. The term ext(X) represents the extreme points of the set of plausible demands X. Because ext(X) is a finite set, this optimization is a linear program.

At 608, the above LP is solved to obtain a robust inventory plan.

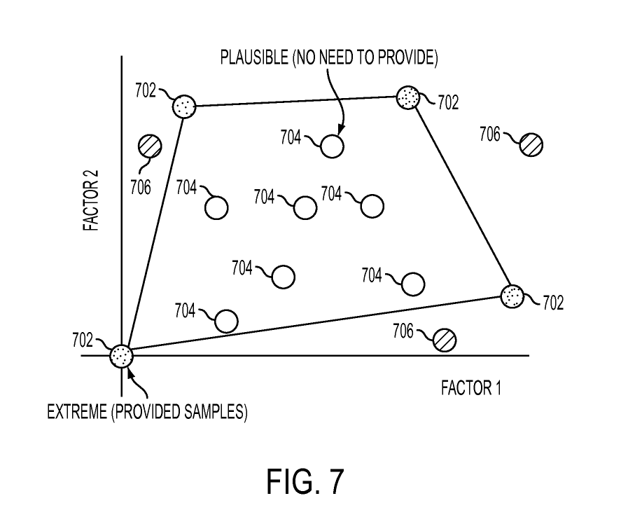

FIG. 7 shows an example of a feasible set of uncertainties for two factors. The dark blue points 702 indicate the extreme samples, which are provided by the user in one embodiment of the present disclosure. Any plausible examples 704—light blue points—do not need to be provided and are automatically optimized for, in one embodiment of the present disclosure. The red points 706 denote implausible examples, which do not need to be provided by the user, in one embodiment of the present disclosure.

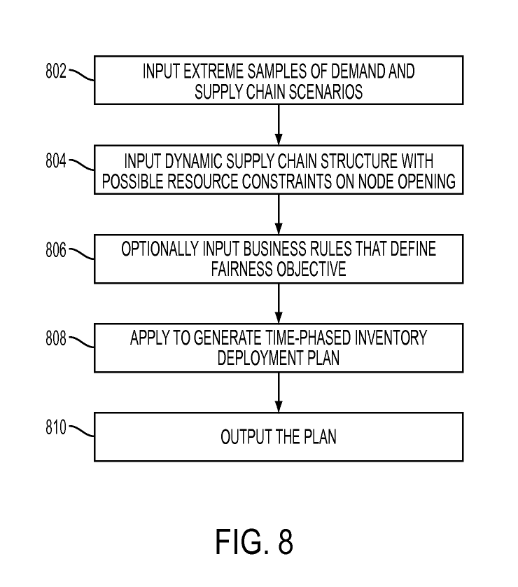

FIG. 8 is a flow diagram illustrating a method of the present disclosure in one embodiment. At 802, extreme samples of demand and supply chain scenarios are received. Extreme samples of demand and supply chain scenarios refer to the extreme points in FIG. 5 and FIG. 7. These examples define the set of uncertainties X and may be generated manually by a domain expert or automatically by sampling from an appropriate model. The samples are used as inputs to the optimization methodology.

At 804, dynamic supply chain structure with possible resource constraints on node opening is received. The supply chain model is a directed acyclic graph. The nodes represent inventory points with limited storage capacity and the edges represent transportation links with limited transportation capacity. Each edge has lead times and maximal transportation capacities associated with it. The nodes may be provided with given opening times when they start their operation. Optionally, a resource constraint on the maximal number of nodes to be open can be provided, and the system determines which nodes should open. All of the provided values may be time phased. This supply chain structure is used as an input to the optimization methodology in one embodiment of the present disclosure.

At 806, optionally, business rules that define fairness objective may be received and used as input to the optimization methodology. In one embodiment of the present disclosure, these fairness rules are defined by providing an appropriate function μ(x) where x is a vector of coverages; each elements represents the coverage for one stock/inventory node. The function μ(x) satisfies the conditions described above. Some simple examples of acceptable fairness measures are:

$$Average coverage \text{:} μ ( x ) = {\sum }_{i = 1}^{n} {x}_{i}$$

$$Worst \text{-} case coverage \text{:} μ ( x ) = {max}_{i = 1 … n} {x}_{i}$$

At 808, the extreme samples received at 802 are applied to generate time-phased inventory deployment plan that, for example, is robust to uncertainty and incomplete information and also observes the constraints of the dynamic supply chain. For instance, the LP program is solved using the input values. The time-phased inventory deployment plan may also meet the fairness objective defined at 806.

At 810, the supply chain plan is output.

The following describes an example of inventory model defined according to one embodiment of the present disclosure. The formal inventory model in this example is for disaster response. The example model assumes shipments in a simple network flow and discretized time interval. The model focuses on a single commodity only for explanation sake; however, its extension to multiple commodities is straightforward. The single commodity in this example is water in the example scenario setting. The general unit used throughout the formulation is a single truckload, but fractional loads can be also considered.

There are many uncertainties involved in responding to a disaster: the extent of the damage and injuries is rarely known with great precision during the initial stages of the disaster. There is, therefore, a great deal of uncertainty in the demand that needs to be satisfied, the travel times, damage to stock nodes, and transportation capacities. To simplify the setting, this model focuses on the uncertainties in the demands. This uncertainty makes the greatest difference in the response. The example model can be extended to include many other types of uncertainties.

The following symbols are used to denote the parameters of the supply chain.
T Planning time horizon ({0 . . . T})
N Set of stock nodes in the supply chain. This set corresponds to the nodes in the supply chain graph.
c Stock node storage capacities (N→R₊)
d True demand at each time step (unit, T×N→R)
d Expected (forecasted) demand at each time step (unit, T×N→R)
\hat{d} Deviation in demand from the forecast demand at each time step (unit, T×N→R)
L Set of transportation links forming a directed acyclic graph (⊂N×N)
l Transportation lead times for each link (time steps, L→N₊)
q Loading/unloading throughput for each stock node (units per time step, N→N₊)
z Initial inventory in each stock node (units, N→R₊)
r Replenishment rate for each stock node (units, N→R₊)
cₕ Backlogging costs at stock node (price per unit, N×T→R₊)
cₗ Backlogging transportation costs on link (price per unit, L×T→+R₊)

The following symbols are used to denote the decision variables and related derived values.
f Inventory shipped along an edge at each time step (unit, L×T→R₊)
x Inventory levels at stock nodes at each time step (unit, N×T→R₊)
b Backlog at stock nodes (unit, b(w,t)=[−x(w,t)]₊)), where [ ]₊ represents the non-negative part of the value
σ Coverage at each time unit (σ(w,t)=b(w,t)/Σₛ₌₀^{l}d(w,s)) is the backlog as a fraction of the demand at the node

The term R represents the set of all real numbers and the term R₊ represents the set of all non-negative real numbers. Similarly, the term N₊ represents the set of all (non-negative) natural numbers. The notation N→R₊ denotes a function from the set of all nodes to the set of non-negative real numbers.

Generally, t∈T is used to index time steps, w∈N to index stock nodes, and e∈L to denote transport links.

Deterministic Formulation

The following general assumptions are made:

Stock nodes model all levels of the supply chain, including the points of demand.

Backlogging is allowed only for the demand nodes of the supply chain.

Transportation lead times include all time necessary to load and unload shipments.

Transportation links are unidirectional and the transportation network is acyclic.

The decisions satisfies the following set of constraints.

Inventory dynamics of shipments and deliveries. ∀w∈N, t∈T:

$$x ( 0 , w ) = z ( w )$$

$$x ( w , t ) = x ( w , t - 1 ) + {\sum }_{\{ {t}^{′} : {t}^{′} = t + l ( {w}^{′} , w ) \}}^{ } {\sum }_{{w}^{′} ∈ N}^{ } f ( w , {w}^{′} , {t}^{′} ) - {\sum }_{{w}^{′} ∈ N}^{ } f ( w , {w}^{′} , {t}^{′} )$$

The inventory dynamics constraints ensure the preservation of the total inventory at any step of the time. The first equations ensures that the inventory x at each node w is initialized to the provided value z. The second equation ensures that the inventory level x(w,t) at time t equals the inventory at the previous time step x(w,t-1) plus the inventory received from other nodes w′ minus the inventory shipped. The incoming inventory from any node w′ is delayed by the lead time l(w′,w).

Inventory flow into and out of a stock node is limited by the throughput.

$$∀ w ∈ N , t ∈ T : \\ {\sum }_{\{ {t}^{′} : {t}^{′} = t + l ( {w}^{′} , w ) \}}^{ } {\sum }_{{w}^{′} ∈ N}^{ } f ( w , {w}^{′} , {t}^{′} ) - {\sum }_{{w}^{′} ∈ N}^{ } f ( w , {w}^{′} , {t}^{′} ) \leq q ( w )$$

This constraint represents the limit q(w) on the processing capacity of each stock node w. The first term on the left hand-side represents, just like in the inventory equation above, the amount of goods received from all nodes w′. The second term on the left-hand side represents the amount of goods shipped from a node.

The amount of goods that can be held at a stock node is limited by the capacity. ∀w∈N, t∈T:

x(w, t)≦c(w)

To simplify the notation, the constraints above are written as:

$$A ( \begin{matrix}f \\ x\end{matrix} ) \geq b ,$$

for the appropriate matrix A and vector b. Note that this formulation does not include the demands. Assuming that the precise demands d are known, one can formulate the following fractional linear program:

$$min {\sum }_{t ∈ T , w ∈ N}^{ } [ b ( w , t ) ] \text{/} {\sum }_{w ∈ N}^{ } {\sum }_{{t}^{′} = 0}^{ } d ( w , {t}^{′} ) \\ s . t . A ( \begin{matrix}f \\ x\end{matrix} ) \geq b \qquad ( 1.1 )$$

The objective function (1.1) represents the average converage. In particular, the numerator represents the sum of all backlogs over all time periods and all stock nodes. The denominator represent the sum of demands. And the coverage is the backolg divided by the demand. This optimization, however, does not yet address uncertainties and relies on precise knowledge of the demands, and does not yet attempt to achieve fair coverage over the stock nodes. The model is further developed as follows to address those features in one embodiment of the present disclosure.

In the following, the general framework for dynamic inventory optimization problems is described including the dynamics, the uncertainty models, and measure of fairness, which can be used to model supply chains, e.g., in disaster responses.

Measures of Coverage Quality

In one embodiment of the present disclosure, a new set of measures is used to evaluate the measure of coverage of the demand achieved with the given resources. These measures may be used to combine the coverage levels or backlog from multiple stock nodes into a single number. To do that, we define so called fairness measures and the general mathematical model. Fairness measures in one embodiment are meant to minimize the discrepancy among the coverage rates of different stock nodes.

Definition 1: A function μ: R^{N}→R represents a fairness measure when it satisfies the following conditions:

Convexity: μ(αX+(1−α)Y)≦αμ(X)+(1−α)μ(Y) for α∈[0,1] 1.

Uniform indifference: μ(X+1)=μ(X)+c 2.

Positive homogeneity: μ(cX)=cμ(X)for c≧0 3.

The properties above have the following meaning. The convexity property ensures aversion to unfair coverage results. In particular, if X and Y are two possible coverage results, the measure of their weighted average is no worse than the weighted average of the respective measures. The second property ensures an indifference to uniform change in the coverage (uniform over all stock nodes). The third property guarantees that scaling of the converage results into identical scaling of the measure; in other words the fairness measure also represents fractional coverage.

Fairness measures may be similar to risk measures, which have been used in mathematical finance to minimize risk of a stochastic solution. The following proposition states an alternative formulation of a fairness measure.

Proposition 1: A function μ: Z→R is a coherent risk measure if and only if there exists a set of probability measures Q such that for all X∈Z :

$${min}_{x , f} μ [ b ( w , t ) ] \text{/} {\sum }_{w ∈ N}^{ } {\sum }_{{t}^{′} = 0}^{ } d ( w , {t}^{′} ) \\ s . t . A ( \begin{matrix}f \\ x\end{matrix} ) \geq b \qquad ( 2.1 )$$

The proposition follows Hans Follmer and Alexander Schied. Stochastic Finance: An introduction in discrete time. Walter de Gruyter, 2011.

To use fairness measures in linear programs, we define polyhedral fairness measures to be fairness measures for which the set Q in proposition 1 is a polytope. A polytope is a closed and bounded polyhedron. Some examples of fairness measures for a single time period are:

Average backlogs:

$$μ ( b ) = \frac{1}{\vert N \vert} {\sum }_{w ∈ b}^{ } b ( w ) .$$

This represents the average backlog over all stock nodes.

Worst-case backlog: μ(b)=max{u^{T}[b]:u≧0,1^{T}u=1}=max{u^{T}b:u≧0,1^{T}u≦1}. This represents the highest backlog over all stock nodes. That is, if there are three nodes with backlogs 1,3,2 respectively, then μ(b)=3.

Second-order backlog measure: μ(b)=max{u^{T}[b]₊:u≧0,∥u∥₂=1}=max{u^{T}[b]:∥u∥₂=1}=∥[b]₊∥₂ This represents an intermediate measure between “average backlog” and “worst-case backlog”.

Using the fairness measures, the deterministic optimization in Eq. (1.1) above can be reformulated to:

$${min}_{x , f} μ [ b ( w , t ) ] / {\sum }_{w ∈ N}^{ } {\sum }_{{t}^{′} = 0}^{t} d ( w , {t}^{′} ) \\ s . t . A ( \begin{matrix}f \\ x\end{matrix} ) \geq b \qquad ( 2.1 )$$

Open Loop Control Optimization Problem: Demand Uncertainties

Now, we discuss options for defining demand uncertainties. As mentioned before, we use the robust model of uncertainty in one embodiment of the present disclosure: we compute a solution that works best for the worst-case realization of the demands.

The assumed input to the optimization is demand forecast d with the possible deviations defined by \hat{d}. Assume a given set of \hat{d}₁, \hat{d}₂, . . . , \hat{d}ₙ. The first option is to define the demands as follows:

G= g̅+conv({\hat{d}₁, \hat{d}₂, . . . , \hat{d}ₙ}).

Here, conv(·) represents a convex hull. Note that G can be also represented by a set of linear inequalities; the number of vertices can be exponential in the number of inequalities. p Given the set specifying the uncertainty in the demands, the robust solution counterpart of Eq. (2.1) is then defined using demand deviations as follows:

$${min}_{x} {max}_{g ∈ G} c ( x , g ) \\ x . t . Ax \geq b \qquad ( 2.2 )$$

Here, the cost function is defined as:

$$c ( x , g ) = {\sum }_{w ∈ N , t ∈ T}^{ } {{c}_{b} ( w , t ) [ - x ( w , t ) + {\sum }_{{t}^{′} < t}^{ } \hat{d} ( w , {t}^{′} ) g ( w , {t}^{′} ) ]}_{+} ,$$

where [ ]+ represents the non-negative part of the number. The cost function corresponds to worst-case demand d less the deliveries x. The value g corresponds to the realization of the uncertain demand. The inner maximization in (2.2) corresponds to the worst-case plausible demand, which is an actual realization of the demand that leads to the worst coverage for the given inventory plan x.

Since the function c is convex, the inner optimization problem is not convex. Note also that this is an open loop control. In the following description, the above model is further developed to provide tractable conditions and to be able to respond to learning about the demand disturbances.

The representation of the uncertainty set in terms of its extreme points above has several advantages in our setting. First, it is often easier to describe most extreme plausible samples than to derive the appropriate linear inequalities. Second, we propose algorithms that have a polynomial running time in the number of extreme points.

The straightforward definition of the uncertainty set above is hard to apply in the large-scale disaster response setting, because the inventory levels need to be computed across many stock nodes and time steps. The problem is that the uncertainty is represented using its effects. However, even though the uncertainty has an effect on a large number of stock nodes, it is usually caused by a small number of causes. This would be typically a higher or lower intensity of the disaster. Therefore, there are significant correlations between the demand deviations. To capture the sparsity of the demand deviations and to enable scalability, we define a factored representation of the demand uncertainty.

Assume a given set of factors Hⱼ⊂N×T for j=1 . . . m along with corresponding extreme values ξ₁(j), ξ₂(j) . . . , ξₙ(j). The uncertainty can be represented:

$$G = conv ( \{ {g}_{i} : ∀ {ig}_{i} = \overline{g} + {\sum }_{j}^{ } \overline{g} {\vert}_{{H}_{j}} ξ ( j ) \} \} ) .$$

Note that the set G is small-dimensional with the dimension being the number of factors. The values gᵢ represent the possible demand scenarios and the variables ξ are used to represent the uncertainty realization for the individual factors. g̅|_{H}_{ⱼ} denotes a restriction of the elements of g̅ to elements in the set _{H}_{ⱼ}.

Affinely Adjustable Controllers

We define a closed loop controller. Unlike an open loop controller, a closed loop controller is able to respond to demand disturbances after the information is obtained. Note that while it is often after the disturbance is realized, it may very well be before that. We therefore define for factors not only the nodes and times they influence but also the time when their value is learned and the response can start.

The inventory x(w,t) and f(e,t) now also depend on the demand disturbances. To simplify the notation, we use y to denote both x and y and write y(d) to denote that y is a function of d. y is a non-anticipative function of d; that is, y does not depend on future disturbances. The adjustable optimization equivalent of (2.2) can be written as follows:

$${min}_{y ( d )} {max}_{d ∈ G} {μ [ - y ( d ) + d ]}_{+} / {e}^{T} d \\ s . t . {min}_{d ∈ G} Ay ( d ) \geq b \qquad ( 2.3 )$$

for some matrix A and vectors b. Here e is a vector of values 1/|d| where |d| is the total number of stock nodes times the number of time steps. Other terms correspond to those described in (2.2). The value y represents the affine adjustable controller; y is an affine function that maps any vector of demands d to a vector of deliveries to all nodes.

Since the closed loop optimization looks for a policy that responds to all contingencies, not a static plan, it is much harder to compute. In fact, note that G may be infinite and there are, therefore, infinite number of possible scenarios. Such problems can be solved approximately, using for example approximate dynamic programming, e.g., described in Warren B. Powell. Approximate Dynamic Programming. Wiley-Interscience, 2007. In one embodiment of the present disclosure, the robust formulation is applied to compute a simpler solution. In particular, we restrict the dependence of y on d to be affine.

The restriction to affine controllers implies that there exists a matrix Q and a vector q , such that:

y(d)=Qd+q,

where some elements of Q are constrained appropriately to 0 in order to achieve non-anticipativity. The adjustable optimization problem (2.3) then becomes:

$${min}_{Q , q} {max}_{d ∈ G} {μ [ - Qd + q + d ]}_{+} / {e}^{T} d \\ s . t . {min}_{d ∈ G} Ay ( Qd + q ) \geq b \qquad ( 2.4 )$$

While (2.4) is not quite a convex optimization problem, it is a much smaller and more manageable problem than (2.3).

Constraint Generation Approach

The following describes the methods for solving (2.4) in one embodiment of the present disclosure. The difficulty in computing the solution is that the function −Qd+q+d is convex in d and therefore max_{d∈G}−Qd+q+d is a convex maximization problem. In fact, Dimitris Bertsimas and Vineet Goyal, On the power and limitations of affine policies in two-stage adaptive optimization, Mathematical Programming, 2011, show that this problem is in general NP hard to solve even for two stages.

An approach to addressing the intractability of (2.4) is to assume a specific structure of the uncertainty set. Two assumptions that guarantee tractability is rectangularity and sublinearity . Rectangularity assumes that the uncertainty is only constrained by a weighted L_{∞} norm and sublinearity assumes that it is only constrained by a very specific L₁ norm. It is very rare for practical problems to satisfy these assumptions. Instead, safe approximations may be computed that correspond to outer approximations of the uncertainty sets by a rectangular or a sublinear set. See, Aharon Ben-Tal and Laurent El Ghaoui and Arkadi Nemirovski, Robust Optimization, Princeton University Press, 2009.

Experimental results indicate that the safe approximation approach may lead to solutions of low quality. In the present disclosure, we use an alternative approach that corresponds to constraint generation.

While the approximation may be used in both adjustable and non-adjustable optimization to achieve tractability, in the present disclosure in one embodiment, we explore a constraint generation approach to achieving tractability. This makes sense, because the backlog will most likely be positive for most stock points during most of the time intervals and most of the stock points. In this model in one embodiment, the uncertainty is defined by the vertices of the polytope. The optimization problem is as follows.

$${min}_{x ∈ X} {max}_{y ∈ Y} {max}_{u ∈ U} {u}^{T} x ( y ) .$$

Here, X represents the set of feasible inventory positions—it is a function of the uncertainty as an affine controller. Y represents the set of uncertainties—a polytope. The set U represents the measures associated with the risk measure. Using the convexity of the function:

Theorem I: The following equality holds:

$${min}_{x ∈ X} {max}_{y ∈ Y} {max}_{u ∈ U} {u}^{T} x ( y ) = {min}_{x ∈ X} {max}_{y ∈ extY} {max}_{u ∈ U} {u}^{T} x ( y ) .$$

This equality states that the continuous maximization of y can be transfortmed to a combinatortial one; replacing the continuous set Y by the set of its vertices ext Y. Assume that the set of demands is defined as:

D={d:Ed≦f,d≧0}.

The optimization can be then expressed as follows:

$$\begin{matrix}{min}_{x ∈ X} {max}_{d ∈ D} {\sum }_{i}^{ } {d}_{i} - {x}_{i} = {min}_{x ∈ X} {max}_{d ∈ D} {max}_{w} \\ \{ {w}^{T} ( {d}_{i} - {x}_{i} ) : w \geq 0 , w \leq 1 \} \\ = {min}_{x ∈ X} {max}_{w ∈ W} {max}_{d ∈ D} {w}^{T} ( d - x ) ,\end{matrix}$$

$$where$$

$$W = ext ( \{ w : w \geq 0 , w \leq 1 \} ) .$$

Taking the dual of the inner problem:

$${min}_{x ∈ X} {max}_{w ∈ W} {min}_{λ : {E}^{T} λ \geq w , λ \geq } {f}^{T} λ - {w}^{T} x .$$

This is equivalent to the following linear program:

$${min}_{x , t , {λ}_{w}} t$$

$$s . t . t \geq {f}^{t} {λ}_{w} - {w}^{T} x ∀ w ∈ W$$

$${E}^{T} {λ}_{w} \geq w$$

$$λ \geq 0$$

$$x ∈ X$$

This program can be solved using constraint and column generation on the set W.

The symbols in the equations above have the following meaning. The values E and f are provided by the user in one embodiment of the present disclsoure and represent the definition of the uncertainty. These values may be provided in a matter consistent with the description of the factored uncertainty above. The value λ is an auxialliary variable that comes from the dualization and there is one variable for each element w. The set W is the set of all extreme demand scenarios and w are elements from this set. The value x represents the total deliveries and X is the set of possible deliveries that satisfy the constraints on lead times and capacities described above.

The robust model in one embodiment of the present disclosure adjusts to future disturbances using linear controllers on the demand. It assumes a forecast with possible future disturbances and uses the links that result from the continuous model and attempts to match its coverage.

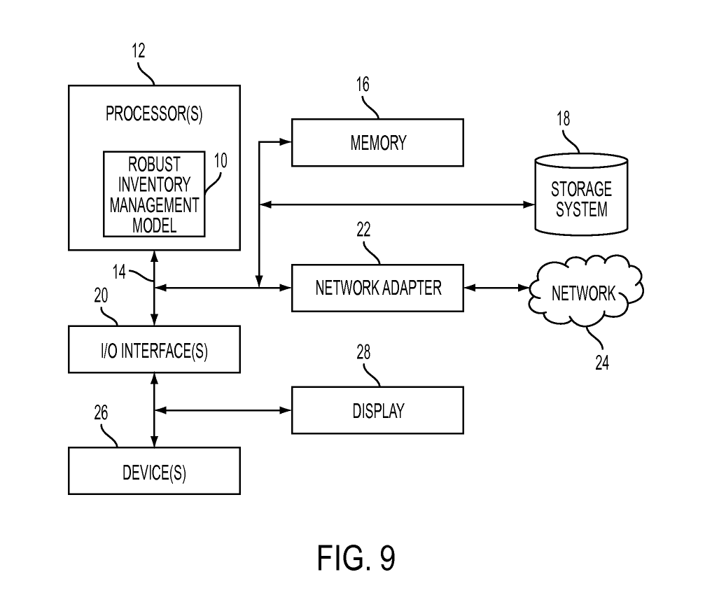

FIG. 9 illustrates a schematic of an example computer or processing system that may implement the robust inventory planning system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 9 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a robust inventory planning module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writinv, to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Peri, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for inventory management for a supply chain network with multiple nodes, comprising:
receiving extreme samples of demand and supply chain scenarios;
receiving dynamic supply chain structure including one or more resource constraints associated with one or more nodes in the supply chain network;
generating, by a processor, a time-phased inventory deployment plan based on said extreme samples and said dynamic supply chain structure; and
outputting said time-phased inventory deployment plan.

2. The method of claim 1, further including:
receiving one or more rules defining a coverage of percentage of satisfied demand across the multiple nodes, wherein the generating step is performed based further on said one or more rules.

3. The method of claim 1, further including:
automatically generating a set of plausible demands based on the received extreme samples.

4. The method of claim 1, wherein the generating step further includes solving an optimization function that computes an adjustable controller used to respond to demand in the demand and supply chain scenarios.

5. The method of claim 1, wherein the generating step further includes computing an affine adjustable controller that provides solutions parameterized by uncertainty values.

6. The method of claim 1, wherein the generating step further includes transforming measure of amount of coverage in demand to a convex optimization problem.

7. The method of claim 1, wherein the generating step includes solving a linear program:
$$\begin{matrix}{min}_{Y ∈ y} {max}_{x ∈ X} μ ( Y ( x ) ) = {min}_{y ∈ Y} {max}_{x ∈ X} {max}_{q ∈ Q} {q}^{T} Y ( x ) - {f}^{*} ( q ) \\ = {min}_{Y ∈ y} {max}_{x ∈ ext X} {max}_{q ∈ Q} {q}^{T} Y ( x ) - {f}^{*} ( q ) = LP\end{matrix}$$
wherein Y̅ represents space of adjustable controllers to be considered, X represents a set of plausible demands, μ is a fairness measure, ext(X) represents the extreme samples of the set of plausible demands X, wherein the linear program computes best possible inventory plan y for worst possible realization of demand x.

8. A computer readable storage medium storing a program of instructions executable by a machine to perform a method of inventory management for a supply chain network with multiple nodes, comprising:
receiving extreme samples of demand and supply chain scenarios;
receiving dynamic supply chain structure including one or more resource constraints associated with one or more nodes in the supply chain network;
generating, by a processor, a time-phased inventory deployment plan based on said extreme samples and said dynamic supply chain structure; and
outputting said time-phased inventory deployment plan.

9. The computer readable storage medium of claim 8, further including:
receiving one or more rules defining a coverage of percentage of satisfied demand across the multiple nodes, wherein the generating step is performed based further on said one or more rules.

10. The computer readable storage medium of claim 8, further including:
automatically generating a set of plausible demands based on the received extreme samples.

11. The computer readable storage medium of claim 8, wherein the generating step further includes solving an optimization function that computes an adjustable controller used to respond to demand in the demand and supply chain scenarios.

12. The computer readable storage medium of claim 8, wherein the generating step further includes computing an affine adjustable controller that provides solutions parameterized by uncertainty values.

13. The computer readable storage medium of claim 8, wherein the generating step further includes transforming measure of amount of coverage in demand to a convex optimization problem.

14. The computer readable storage medium of claim 8, wherein the generating step includes solving a linear program:
$$\begin{matrix}{min}_{Y ∈ y} {max}_{x ∈ X} μ ( Y ( x ) ) = {min}_{y ∈ Y} {max}_{x ∈ X} {max}_{q ∈ Q} {q}^{T} Y ( x ) - {f}^{*} ( q ) \\ = {min}_{Y ∈ y} {max}_{x ∈ ext X} {max}_{q ∈ Q} {q}^{T} Y ( x ) - {f}^{*} ( q ) = LP\end{matrix}$$
wherein Y̅ represents space of adjustable controllers to be considered, X represents a set of plausible demands, μ is a fairness measure, ext(X) represents the extreme samples of the set of plausible demands X, wherein the linear program computes best possible inventory plan y for worst possible realization of demand x .

15. A system for inventory management for a supply chain network with multiple nodes, comprising:
a processor operable to receive extreme samples of demand and supply chain scenarios, and dynamic supply chain structure including one or more resource constraints associated with one or more nodes in the supply chain network, the processor further operable to generate a time-phased inventory deployment plan based on said extreme samples and said dynamic supply chain structure, and output said time-phased inventory deployment plan.

16. The system of claim 15, wherein the processor is further operable to receive one or more rules defining a coverage of percentage of satisfied demand across the multiple nodes, wherein the processor generate the time-phased inventory deployment plan further based on said one or more rules.

17. The system of claim 15, wherein the processor automatically generates a set of plausible demands based on the received extreme samples.

18. The system of claim 15, wherein the processor generates the time-phased inventory deployment plan by solving an optimization function that computes an adjustable controller used to respond to demand in the demand and supply chain scenarios.

19. The system of claim 15, wherein the processor further computes an affine adjustable controller that provides solutions parameterized by uncertainty values.

20. The system of claim 15, wherein the processor further transforms a measure of amount of coverage in demand to a convex optimization problem to generate the time-phased inventory deployment plan.

21. The system of claim 15, wherein the processor generates the time-phased inventory deployment plan by solving a linear program:
$$\begin{matrix}{min}_{Y ∈ y} {max}_{x ∈ X} μ ( Y ( x ) ) = {min}_{y ∈ Y} {max}_{x ∈ X} {max}_{q ∈ Q} {q}^{T} Y ( x ) - {f}^{*} ( q ) \\ = {min}_{Y ∈ y} {max}_{x ∈ ext X} {max}_{q ∈ Q} {q}^{T} Y ( x ) - {f}^{*} ( q ) = LP\end{matrix}$$
wherein Y̅ represents space of adjustable controllers to be considered, X represents a set of plausible demands, μ is a fairness measure, ext(X) represents the extreme samples of the set of plausible demands X , wherein the linear program computes best possible inventory plan y for worst possible realization of demand x.
